(19) United States
(12) Patent Application Publication
(10) Pub. No.: US 2015/0249730 A1
(43) Pub. Date: Sep. 3, 2015

(54) Elastic Adjustable Hand Held Device Holder

(71) Applicant: Larsen Legacy Designs, LLC, Plano, TX (US)

(72) Inventor: April C. Larsen, Plano, TX (US)

(21) Appl. No.: 14/634,567

(22) Filed: Feb. 27, 2015

Related U.S. Application Data
(60) Provisional application No. 61/946,782, filed on Mar. 1, 2014.

(51) Int. Cl. H04M 1/12; G03B 17/56

(52) U.S. Cl. CPC H04M 1/12; G03B 17/561

(57) ABSTRACT

This invention relates to an adjustable hand held device holder and a method of using the same, comprising: an anchor; a first, a second, a third, and a fourth elastic member, wherein the first, second, third and fourth elastic members are secured to the anchor, and wherein at least three of the elastic members are adapted to engage at least three edges or corners of a hand held device.

### CROSS-REFERENCE TO RELATED APPLICATIONS

This application claims priority to U.S. Provisional Application No. 61/946,782 filed on Mar. 1, 2014. The entire contents of which are incorporated herein by reference.

### BACKGROUND OF THE INVENTION

Without limiting the scope of the invention, its background is described in connection with holders for carrying hand held devices and more specifically to carrying cell phones and tablets having a hook for support or to suspend the carrying case.

Hand held devices are supported by multiple rigid products with limited flexibility for connecting or attaching to wearable items or other solid material. This elastic adjustable carrying case will securely fastener around the rigid hand held device to provide the ability to attach the device to wearable items or other solid material, when appropriate, for ease of use or to prevent loss of the hand held device.

The inability to securely attach a hand held device to wearable clothing has created annoyance as society has become increasingly dependent on a cell phone for various activities, including shopping. Using a cell phone application for a shopping list requires that the cell screen must be locked, placed in a pocket or purse, to free both hands for reaching or searching for items on a store shelf or bin. This scenario is repeated multiple times throughout the shopping trips. Time is wasted with the task of securing a cell. What is needed is a removable wearable device that allows constant use of the cell phone while freeing both hands for various activities.

U.S. Patent Application Publication No. US2006/0105821 issued to Goradesky teaches a fastener-around carrying case with a front, rear, and other sides having at least one swatch of elastic materially to laterally compress the phone or personal electronic device in the carrying case. The case also teaches that fasteners may replace the elastic panel, and the further addition of a base or bottom cap can limit shock and protect the bottom of the carried device. The application also teaches a laterally extending tab that can be utilized to enhance further portability of the carrier. A swing cap may also be utilized to cover the top end of the carried device.

U.S. Patent Application Publication No. US2006/0183518 issued to Emano teaches a system or case for the folding of a cellular phone having an associated viewing window and includes a semi-rigid substantially rectangular case for effecting the selectable securement of a cellular phone. The application teaches that the case has a front major base and a rear major base having an opening substantially proportioned in size and shape to the viewing window and keypad of the cellular phone when the phone is secured in the case. The application also teaches that the system further includes a pressure actuated closure means within the rear major base and to the left and right of the opening, as well as the back panel at locations congruent to the rear major base. The system also includes a belt clip for selectable manual securement to a belt of a user.

U.S. Patent Application Publication No. US2007/0228099 issued to Beda teaches a carrying case for a portable electronic device that includes a padded front and back element coupled together by two or more elastic side elements. The elastic elements permit the carrying case to be used to house electronic devices of slightly different dimensions. The application also teaches that the outer surface of the front is substantially totally covered with pre-arranged bling in a pattern and is provided with an adhesive backing sheet for holding the bling to the outer surface.

U.S. Patent Application Publication No. US2011/0162121 issued to Klann teaches a user object securing assembly for securing a user manipulative object such as user interface at a user-accessible area of a user-wearable garment. The publication teaches that the assembly includes a flap having a first edge for joining to the user-accessible area of the garment to form a generally horizontal hinge line, and a second, opposite, edge which may be free. A fastening device releasable fastens the flap in its closed position. The user manipulative object may include a user interface such as a cell phone or the like, as well as other objects including a billfold, wallet, credit card holder, coin carrier and the like.

U.S. Patent Application Publication No. US2014/0091116 issued to Yu discloses a system and method to conveniently carry a mobile device on a hand brace. The publication teaches the system having a case to enclose the mobile device and a system to wear the apparatus on a hand. The system comprises a case, a case tether coupled to the case, a hand brace shafte coupled to a hand brace and a case lock to hand held device holder the case in a closed position.

U.S. Pat. No. 6,519,207 issued to Lukacsko discloses an all-weather watch to be worn on the outside of the gloves of a glove wearer, such as a skier, snow boarder, hunter, or motorcyclist, in cold and/or inclement weather. The patent teaches that the watch includes a length-adjustable elastic strap that comprises a front strap portion which extends from the watch case and stretches to loop about at least one glove finger. A rear strap portion that extend from the case and stretches outwardly to loop about the glove wrist to position the watch on the back of the glove. The patent teaches that the rear strap portion is maintained in position by the stretching of the elastic strap, the friction between strap and the glove by the cinching action of the loop around the glove wrist and thus does not require the use of a clasp or other fastener.

U.S. Pat. No. 8,428,664 issued to Wyers discloses a protective case assembly for handheld electronic devices. The assembly includes a shell defining an open front and having sides as well as a base which adjoins the shell's sides. The shell attaches to the handheld device by being sized and configured to fit over the backside and side of the device. The patent teaches that the cases assembly includes an elongated elastic strap of predetermined length and width which is attached at its ends to the back of the shell.

U.S. Pat. No. 8,499,933 issued to Ziemba discloses a compartmentalized protective case for housing a portable electronic device and personal care items. The patent teaches that the case has a major compartment for receiving and housing an electronic device such as a smart phone, cellular phone, music player, or other digital media device. There is also at least one cell compartment constructed within the case that receives and houses personal care items removably integrated therein. A second cell compartment is preferably provided as a removable pouch or restraining system for holding identification cards, currency, visa or bank cars, and/or keys.

### SUMMARY OF THE INVENTION

In one embodiment, the present invention is an adjustable hand held device holder comprising an anchor, a first, a second, a third, and a fourth elastic member, wherein the first, second, third and fourth elastic members are secured to the anchor, and wherein at least three of the elastic members are adapted to engage at least three edges or corners of a hand held device. In one aspect of the present invention a portion of at least one elastic member is secured to a portion of another elastic member by a fastener to provide tension and a suspension base. In another aspect, the first, second, third, and fourth elastic members are each elastic bands adapted to engage the edges or corners of a hand held device. Another aspect of the present invention is that upon the securing of at least two elastic members together with a fastener, the fasteners are slidable along the elastic members they secure to allow the adjustment of tension and size for various sizes of hand held devices. It is also noted that the present invention when used to hold a hand held device can provide a layer of cushion or protection for the hand held device. In another aspect of the present invention, each elastic member may further comprise hook or clasps adapted to engage the edges or corners of the hand held device. In another aspect of the present invention, the holder may also includes a ring and/or a hook engaged with at least one elastic member to enable the adjustable hand held device holder to be suspended. The hook and/or ring can make attaching the holder to a necklace, mount, strap, clothing, body part or the like, or suspending it from a stationary point easier. The elastic members of the present invention may also further a camera lens partition if needed to provide a viewing opening for a camera lens. The camera lens partition may be movable dependent on the location of the camera lens on the hand held device.

In another embodiment of the present invention, at least two of the holders may be connected to one another to hold a larger hand held device such as a tablet. The hand held device holder would include an additional anchor wherein a fifth, a sixth, a seventh, and an eighth elastic member are secured to the additional anchor, and at least one of the elastic members secured to the additional anchor are secured to at least one of the elastic members secured to the anchor. The additional copies of the holder may be directly or indirectly connected to one another. Through an indirect connection, an elastic members secured to the additional anchor may be connected to at least one of the elastic members secured to the anchor on the other holder by at least one separate elastic member.

In another embodiment, the present invention also includes a method of securing a hand held device comprising: obtaining an adjustable hand held device holder comprising: a anchor, a first, a second, a third, and a fourth elastic member, wherein the first, second, third and fourth elastic members are secured to the anchor, and at least three of the elastic members are adapted to engage at least three edges or corners of a hand held device, followed by securing at least three of the elastic members to at least three edges or corners of the hand held device. In one aspect of the method, a portion of at least one of the elastic members of the adjustable hand held device holder may be secured to a portion of another elastic member to provide tension and a suspension base. The elastic members may be secured by a fastener that may be slidable and/or removable. In another aspect, the first, second, third, and fourth elastic members of the adjustable hand held device holder are each elastic bands adapted to engage the edges or corners of the hand held device. In another embodiment, each elastic member of the adjustable hand held device holder further comprises hooks adapted to engage the edges or corners of the hand held device. In yet another aspect of the method, the holder may also include a ring and/or a hook engaged with at least one elastic member to enable the adjustable hand held device holder to be suspended. The hook and/or ring can make attaching the holder to a necklace, mount, strap, clothing, body part or the like, or suspending it from a stationary point easier. The elastic members of the present invention may also further a camera lens partition if needed to provide a viewing opening for a camera lens. The camera lens partition may be movable dependent on the location of the camera lens on the hand held device.

In one aspect of the present invention, when engaged to hold a hand held device such as a mobile phone or a tablet, the elastic members stretch outward to each of the four corners and are looped over the corners of the hand held device. By engaging the elastic members to each of the four corners creates a frame-like appearance on the opposite side. However, the base side with the anchor has various contact points where the elastic bands are secured or secured to one another for support and tension. In another aspect, the present invention may be connected to another copy of same invention along at least two of the elastic members. The two combined devices would then create a single elastic holder adapted to allow for a larger hand held device such as a table to be suspended from any side.

### BRIEF DESCRIPTION OF THE DRAWINGS

For a more complete understanding of the features and advantages of the present invention, reference is now made to the detailed description of the invention along with the accompanying figures and in which:

FIG. 1 depicts an isometric view of the back of an embodiment of the hand held device holder with an optional vertical support ring, lateral support ring, and hook.

FIG. 2 depicts a back view of an embodiment of the hand held device holder.

FIG. 3 depicts a front view of an embodiment of the hand held device holder.

FIG. 4 depicts a side view of an embodiment of the hand held device holder with an optional lateral support ring.

FIG. 5 depicts another side view of an embodiment of the hand held device holder.

FIG. 6 depicts a top view of an embodiment of the hand held device holder with an optional vertical support ring and hook.

FIG. 7 depicts a bottom view of an embodiment of the hand held device holder.

FIG. 8 depicts an isometric view of the front of an embodiment of the hand held device holder with an optional vertical support ring and hook.

FIG. 9 depicts an isometric view of an embodiment of the hand held device holder being used for a proposed use.

FIG. 10 depicts an isometric view of the back of an embodiment of the hand held device holder with a camera lens partition and optional vertical support ring, lateral support ring, and hook.

FIG. 11 depicts a back view of an embodiment of the hand held device holder with a camera lens partition.

FIG. 12 depicts a front view of an embodiment of the hand held device holder with a camera lens partition.

FIG. 13 depicts a side view of an embodiment of the hand held device holder with a camera lens partition and an optional lateral support ring.

FIG. 14 depicts another side view of an embodiment of the hand held device holder with a camera lens partition.

FIG. 15 depicts a top view of an embodiment of the hand held device holder with a camera lens partition and an optional vertical support ring and hook.

FIG. 16 depicts a bottom view of an embodiment of the hand held device holder with a camera lens partition.

FIG. 17 depicts an isometric view of the front of an embodiment of the hand held device holder with a camera lens partition and an optional vertical support ring and hook.

FIG. 18 depicts an isometric view of an embodiment of the hand held device holder with a camera lens partition being used for a proposed use.

FIG. 19 depicts an isometric view of the back of an embodiment of the hand held device holder with a dual anchor support system and optional vertical support ring and hook.

FIG. 20 depicts a back view of an embodiment of the hand held device holder with a dual anchor support system.

FIG. 21 depicts a front view of an embodiment of the hand held device holder with a dual anchor support system.

FIG. 22 depicts a side view of an embodiment of the hand held device holder with a dual anchor support system.

FIG. 23 depicts another side view of an embodiment of the hand held device holder with a dual anchor support system.

FIG. 24 depicts a top view of an embodiment of the hand held device holder with a dual anchor support system and an optional vertical support ring and hook.

FIG. 25 depicts a bottom view of an embodiment of the hand held device holder with a dual anchor support system.

FIG. 26 depicts an isometric view of the front of an embodiment of the hand held device holder with a dual anchor support system and an optional vertical support ring and hook.

FIG. 27 depicts an isometric view of an embodiment of the hand held device holder with a dual anchor support system being used for a proposed use.

FIG. 28 depicts an isometric view of the back of another embodiment of the hand held device holder with a dual anchor support system and optional vertical support ring and hook.

FIG. 29 depicts a back view of another embodiment of the hand held device holder with a dual anchor support system.

FIG. 30 depicts a front view of another embodiment of the hand held device holder with a dual anchor support system.

FIG. 31 depicts a side view of another embodiment of the hand held device holder with a dual anchor support system.

FIG. 32 depicts another side view of another embodiment of the hand held device holder with a dual anchor support system.

FIG. 33 depicts a top view of another embodiment of the hand held device holder with a dual anchor support system and an optional vertical support ring and hook.

FIG. 34 depicts a bottom view of another embodiment of the hand held device holder with a dual anchor support system.

FIG. 35 depicts an isometric view of the front of another embodiment of the hand held device holder with a dual anchor support system and an optional vertical support ring and hook.

FIG. 36 depicts an isometric view of another embodiment of the hand held device holder with a dual anchor support system being used for a proposed use.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention provides an elastic adjustable hand held device holder for carrying hand held devices such as, e.g., mobile phones, tablets, metronomes, and tuners.

It is an object of the present invention to provide a removable means to support or suspend a hand held device from various contact points, singularly or in multiple, of the elastic adjustable holder. It is another objection of the present invention to provide a removable elastic adjustable hand held device holder that may be secured or released with the use of one hand, such as with a hook or loop material.

It is another object of the present invention to provide a means to hand held device holder the device to clothing for the use of recording while moving when hands are necessary to hand held device holder safe movement from one place to another, such a riding a bike. The present invention secures the separate device to obtain optimum security in carrying or suspending the hand held device.

Another object of present invention is to provide assistance for the following usual activities: suspension of a cell during bathing to avoid water contact but not miss important messages; suspension of a cell or tablet in a cluttered and/or active area that provided clear line of sight (such as a work area or during cooking); easy access to a cell while shopping or walking the dog that did not require pulling the device from a pocket or pouch but allowed use with one hand while it remained securely attached to a person; and hand held device holder suspension to wearable clothing that allowed for the hand held device to record, hands-free, while physically active (such as riding a bike).

Additionally, other aspects of the present invention includes the removable elastic holder being thin enough to slide into a pocket while on the cell phone; the present invention being easy to attach and remove while still providing ample tension and security; and the presenting invention sized to support a range of cell phone sizes while also adaptable to fit a tablet or other hand held device, such as an electronic device.

As used herein, the term “elastic” refers to any material that exhibits recovery from stretching or deformation.

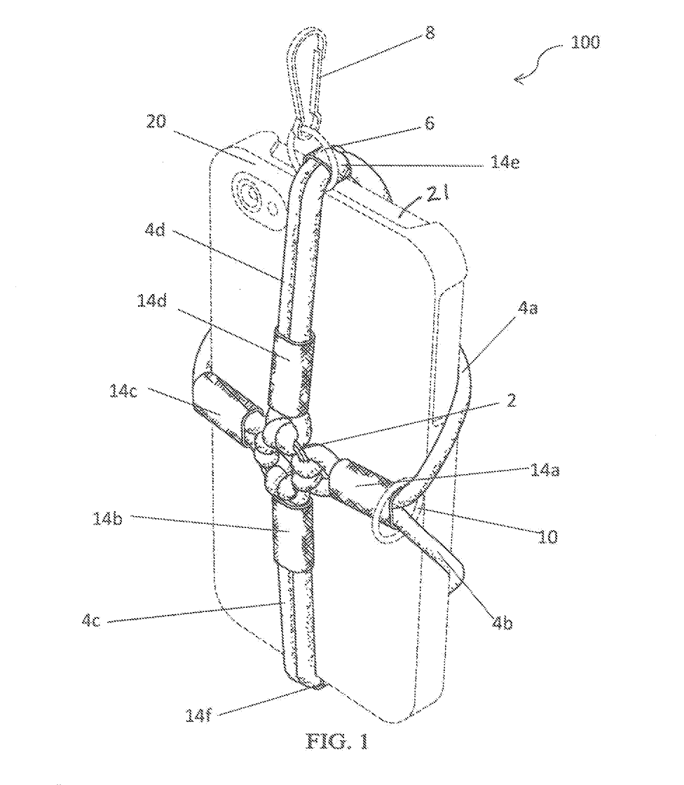

FIG. 1 depicts an isometric view of the back of the hand held device holder 100 according to one embodiment of the present invention. In hand held device holder 100, elastic members 4a-4d are secured to anchor 2. In this embodiment, a portion of elastic member 4a is further secured to a portion of elastic member 4b by a fastener 14a. Fastener 14a-d provide hand held device holder 100 with additional support and tension when engaged to a hand held device case 20 that protects a hand held device 21. Elastic members 4b and 4c, 4c and 4d, and 4d and 4a are also similarly secured together by a fastener 14b-d, respectively.

FIG. 1 shows hand held device holder 100 encasing hand held device case 20 by engaging elastic members 4a-4d to the corners of hand held device case 20. FIG. 1 also depicts hand held device holder 100 with optional vertical support ring 6 connected to elastic members 4a and 4d, and optional lateral support ring 10 connected to the elastic members 4a and 4b. Both can be used to provide hand held device holder 100 with a suspension point. An optional fastener 14e is used in this embodiment to further secure elastic members 4a and 4d to provide a suspension base for vertical support ring 6. A fastener 14f is also used to further secure elastic members 4b and 4c together to further hand held device holder the engagement of hand held device holder 100 on hand held device holder 20. Vertical support ring 6 and lateral support ring 10 can optionally be further connected to a hook 8 (shown here connected to vertical support ring 6) for easier suspension or carrying of the hand held device holder 100 on any side of the hand held device case 20.

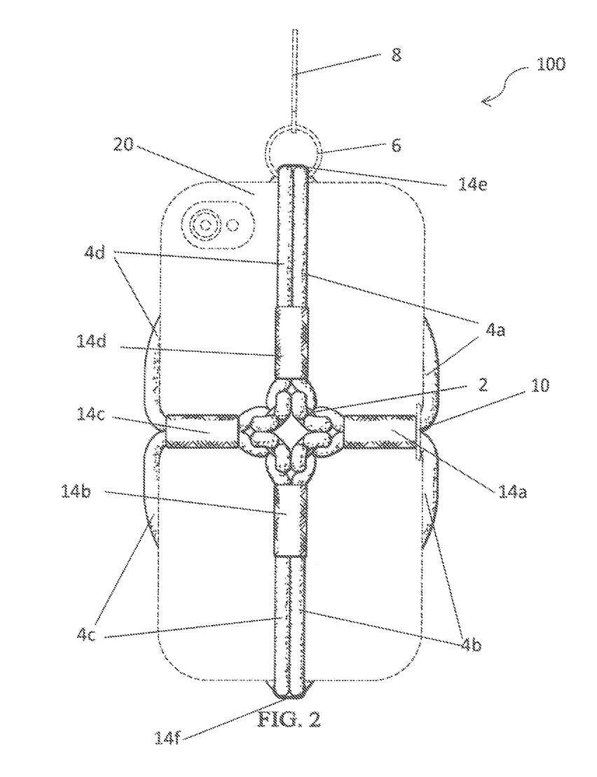

FIG. 2 depicts a back view of hand held device holder 100 encasing a hand held device case 20. Here, elastic members 4a-4d are secured to anchor 2. A portion of elastic member 4a is further secured to a portion of elastic member 4b by a fastener 14a. Elastic members 4b and 4c, 4c and 4d, and 4d and 4a are also similarly secured together by a fastener 14b-d, respectively. FIG. 2 also depicts hand held device holder 100 with optional vertical support ring 6 connected to elastic members 4a and 4d, and optional lateral support ring 10 connected to the elastic members 4a and 4b. An optional fastener 14e also securing elastic members 4a and 4d is used to provide a suspension base for vertical support ring 6. An optional fastener 14f is also depicted securing elastic members 4b and 4c for additional tension. An optional a hook 8 is shown connected to vertical support ring 6 for easier suspension.

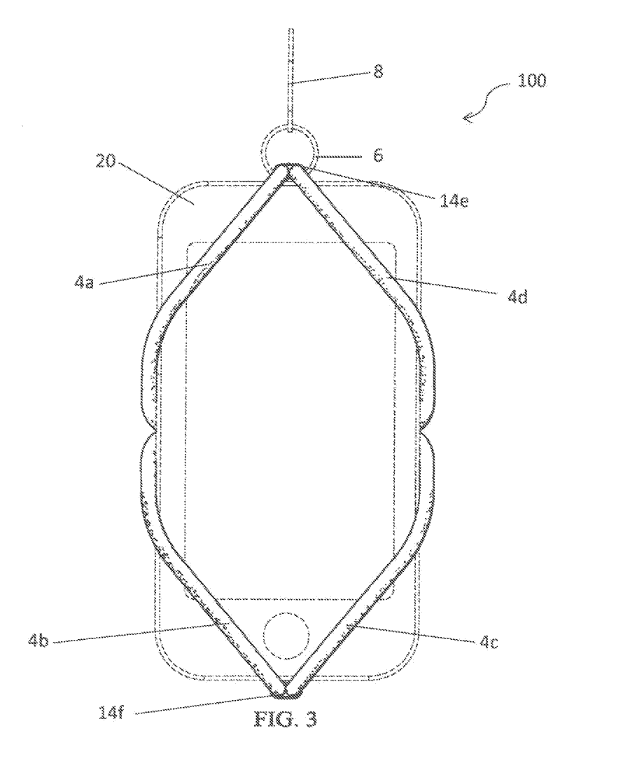

FIG. 3 depicts a front view of hand held device holder 100 encasing hand held device case 20. Elastic members 4a-4d are engaged to hand held device case 20 by looping over the corners of hand held device case 20 creating a frame like appearance. Elastic members 4a and 4d are secured together by a fastener 14e to provide a suspension base for optional vertical support ring 6. Optional hook 8 is shown connected to vertical support ring 6 for easier suspension of hand held device holder 100. Elastic members 4b and 4c are also optionally secured together by fastener 14f for additional tension.

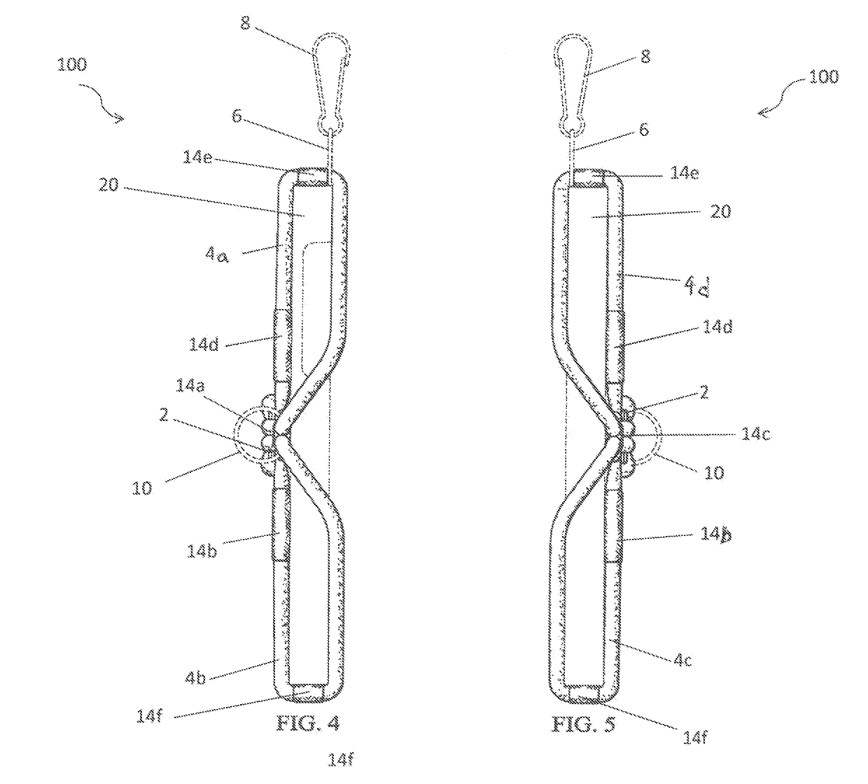

FIGS. 4 and 5 depict side views of hand held device holder 100 encasing hand held device case 20. In FIG. 4, elastic member 4a and 4b are secured to anchor 2 and engaged to hand held device case 20 by being looped over the corners of hand held device case 20. Fastener 14a is shown securing elastic member 4a and 4b. Fastener 14d and 14b are shown securing portions of elastic members 4a and 4b. Vertical support ring 6 is shown connected to elastic member 4a. Hook 8 is shown engaged to vertical support ring 6. Lateral support ring 8 is shown connected to elastic members 4a and 4b. Fastener 14e is shown securing a portion of elastic member 4a. Fastener 14f is shown securing a portion of elastic member 4b. FIG. 5 shows an opposite side view of hand held device holder 100 encasing hand held device case 20. In FIG. 5, elastic member 4d and 4c are secured to anchor 2 and engaged to hand held device case 20 by being looped over the corners of hand held device case 20. Fastener 14c is shown securing elastic member 4d and 4c. Fasteners 14d and 14b are shown securing portions of elastic members 4d and 4c. Vertical support ring 6 is shown connected to elastic member 4d. Hook 8 is shown engaged to vertical support ring 6. Fastener 14e is shown securing a portion of elastic member 4d. Fastener 14f is shown securing a portion of elastic member 4c.

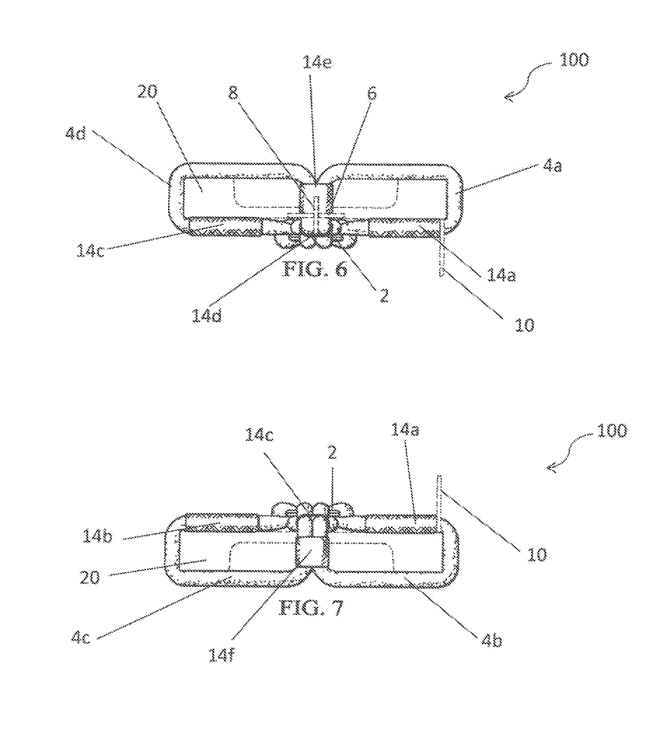

FIG. 6 depicts a top view of hand held device holder 100 encasing hand held device case 20. Elastic members 4a and 4d are secured to anchor 2 and looped over the corners of hand held device case 20. Fastener 14d and 14e both secure elastic members 4a and 4d together. Fastener 14a secures a portion of elastic member 4a. Fastener 14c secures a portion of elastic member 4d. Vertical support ring 6 is connected to elastic members 4a and 4d. Hook 8 is connected to vertical support ring 6. Lateral support ring 10 is connected to elastic member 4a.

FIG. 7 depicts a bottom view of hand held device holder 100 encasing hand held device case 20. Elastic members 4b and 4c are secured to anchor 2 and looped over the corners of hand held device case 20. Fastener 14c and 14f both secure elastic members 4b and 4c together. Fastener 14a secures a portion of elastic member 4b. Fastener 14c secures a portion of elastic member 4c. Lateral support ring 10 is connected to elastic member 4b.

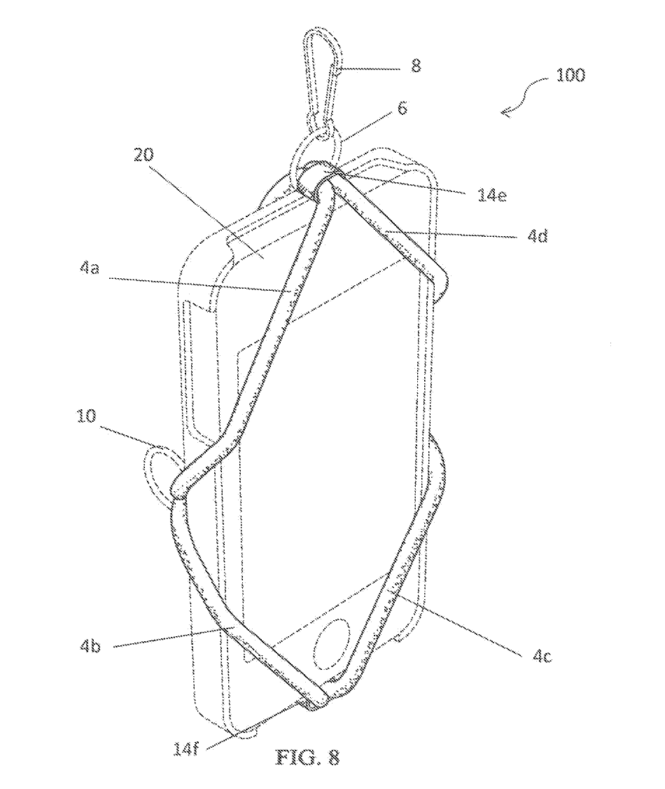

FIG. 8 depicts an isometric view of the front of hand held device holder 100 encasing hand held device case 20 and hand held device 21. Elastic members 4a-4d are engaged to hand held device case 20 by looping over the corners of hand held device case 20 creating a frame like appearance. Elastic members 4a and 4d are secured together by a fastener 14e to provide a suspension base for optional vertical support ring 6. Optional hook 8 is shown connected to vertical support ring 6 for easier suspension of hand held device holder 100. Optional lateral supporting ring 10 is connected to elastic members 4a and 4b. Elastic members 4b and 4c are also optionally secured together by fastener 14f for additional tension.

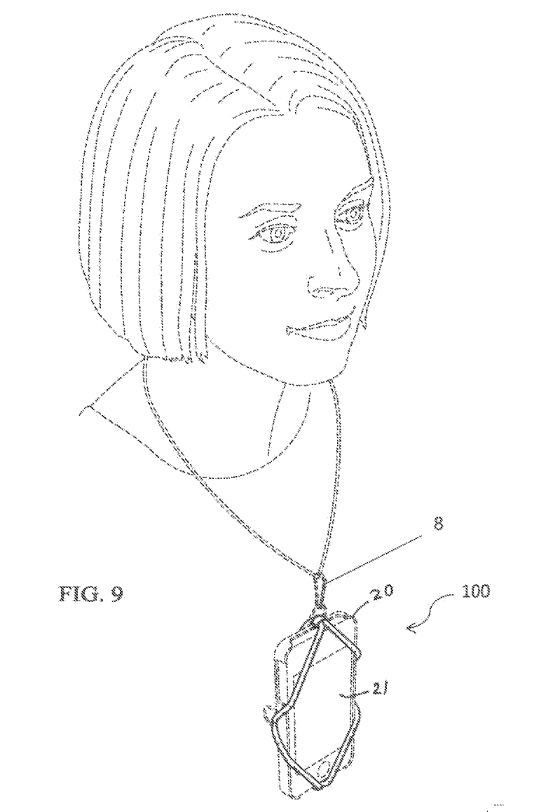

FIG. 9 depicts an isometric view of the front of hand held device holder 100 encasing hand held device case 20 and being used for a proposed use. FIG. 9 shows hook 8 connected to a necklace enabling a user to wear hand held device holder 100 around the neck.

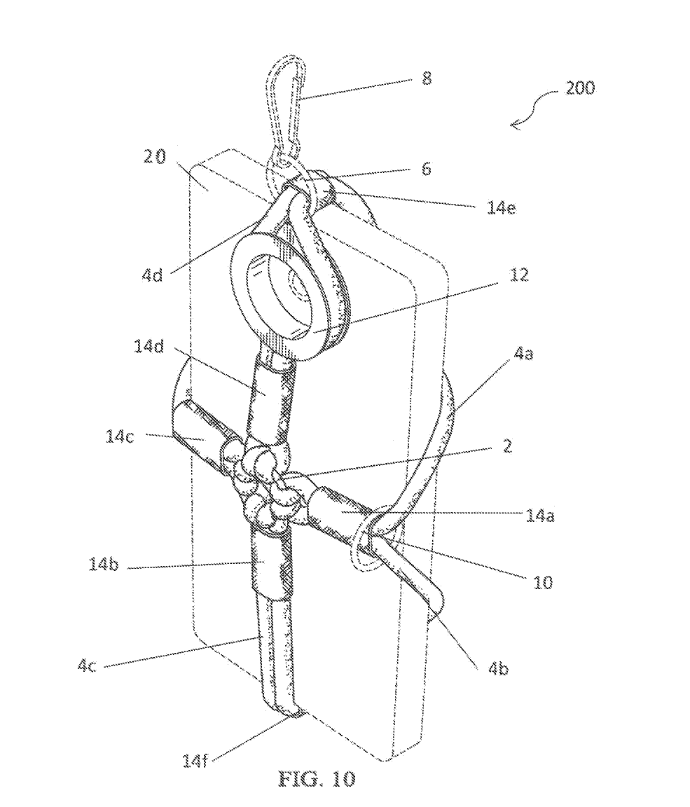

FIG. 10 depicts an isometric view of the back of the hand held device holder 200 according to another embodiment of the present invention. In hand held device holder 200, elastic members 4a-4d are secured to anchor 2. In this embodiment, a portion of elastic member 4a is further secured to a portion of elastic member 4b by a fastener 14a. Fastener 14a-d provide hand held device holder 200 with additional support and tension when engaged to a hand held device case 20. Elastic members 4b and 4c, 4c and 4d, and 4d and 4a are also similarly secured together by a fastener 14b-d, respectively. FIG. 10 shows hand held device holder 200 encasing hand held device case 20 by engaging elastic members 4a-4d to the corners of hand held device case 20. FIG. 10 also depicts hand held device holder 200 with optional vertical support ring 6 connected to elastic members 4a and 4d, and optional lateral support ring 10 connected to the elastic members 4a and 4b. Both can be used to provide hand held device holder 200 with a suspension point. Hand held device holder 200 also contains an optional camera lens partition 12 secured between elastic member 4a and 4d to provide hand held device case 20 with a camera-viewing opening. The optional camera lens partition 12 can be removable. An optional fastener 14e is used in this embodiment to further secure elastic members 4a and 4d to provide a suspension base for vertical support ring 6. A fastener 14f is also used to further secure elastic members 4b and 4c together to further hand held device holder the engagement of hand held device holder 200 on hand held device case 20. Vertical support ring 6 and lateral support ring 10 can optionally be further connected to a hook 8 (shown here connected to vertical support ring 6) for easier suspension or carrying of the hand held device holder 200 on any side of the hand held device case 20.

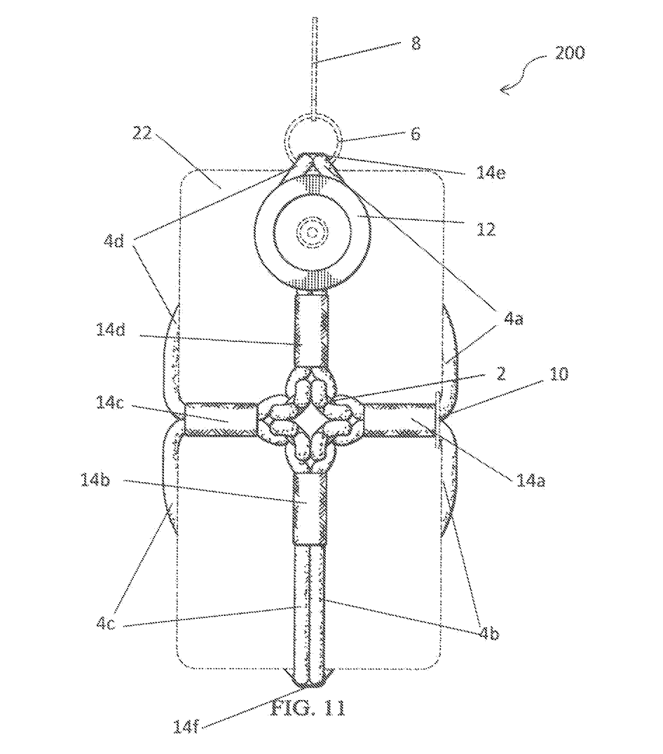

FIG. 11 depicts a back view of hand held device holder 200 encasing a hand held device case 20. Here, elastic members 4a-4d are secured to anchor 2. A portion of elastic member 4a is further secured to a portion of elastic member 4b by a fastener 14a. Elastic members 4b and 4c, 4c and 4d, and 4d and 4a are also similarly secured together by a fastener 14b-d, respectively. FIG. 11 also depicts hand held device holder 200 with optional vertical support ring 6 connected to elastic members 4a and 4d, and optional lateral support ring 10 connected to the elastic members 4a and 4b. Hand held device holder 200 also contains an optional camera lens partition 12 secured between elastic member 4a and 4d to provide hand held device case 20 with a camera-viewing opening. An optional fastener 14e also securing elastic members 4a and 4d is used to provide a suspension base for vertical support ring 6. An optional fastener 14f is also depicted securing elastic members 4b and 4c for additional tension. An optional a hook 8 is shown connected to vertical support ring 6 for easier suspension.

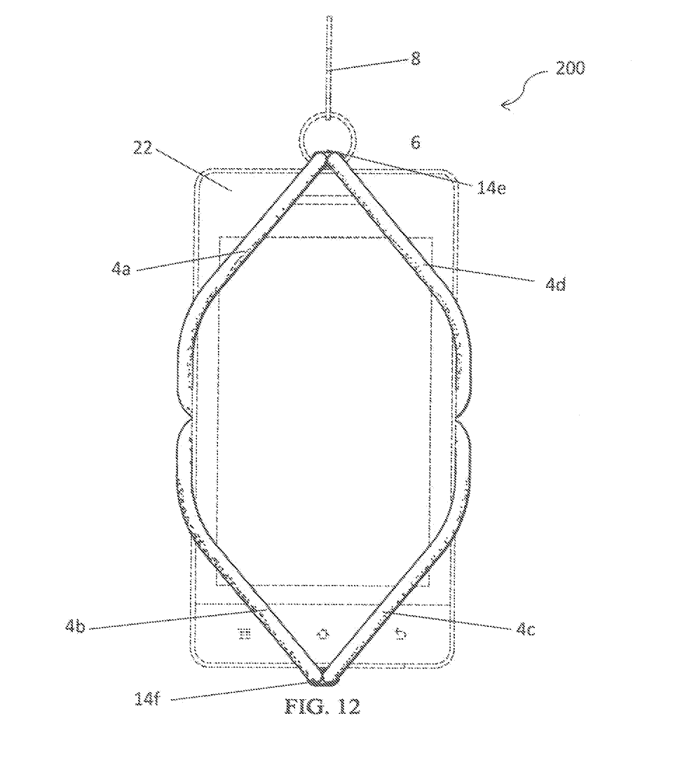

FIG. 12 depicts a front view of hand held device holder 200 encasing hand held device case 20. Elastic members 4a-4d are engaged to hand held device case 20 by looping over the corners of hand held device case 20 creating a frame like appearance. Elastic members 4a and 4d are secured together by a fastener 14e to provide a suspension base for optional vertical support ring 6. Optional hook 8 is shown connected to vertical support ring 6 for easier suspension of hand held device holder 200. Elastic members 4b and 4c are also optionally secured together by fastener 14f for additional tension.

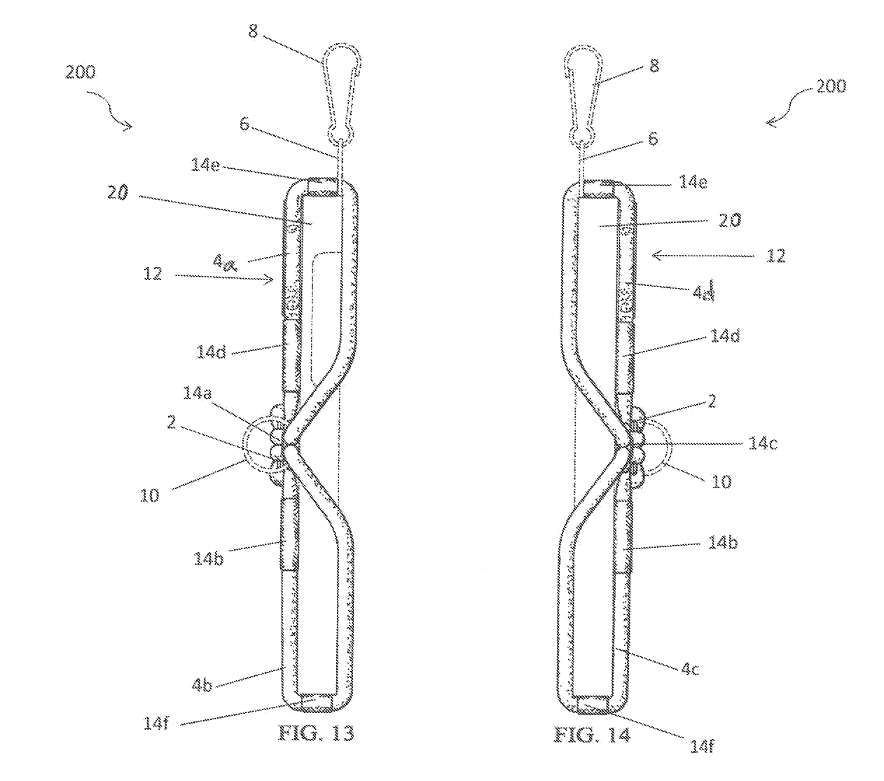

FIGS. 13 and 14 depict side views of hand held device holder 200 encasing hand held device case 20. In FIG. 13, elastic member 4a and 4b are secured to anchor 2 and engaged to hand held device case 20 by being looped over the corners of hand held device case 20. Fastener 14a is shown securing elastic member 4a and 4b. Fastener 14d and 14b are shown securing portions of elastic members 4a and 4b. Camera lens partition 12 is engaged partially into elastic members 4d. Vertical support ring 6 is shown connected to elastic member 4a. Hook 8 is shown engaged to vertical support ring 6. Lateral support ring 8 is shown connected to elastic members 4a and 4b. Fastener 14e is shown securing a portion of elastic member 4a. Fastener 14f is shown securing a portion of elastic member 4b. FIG. 14 shows an opposite side view of hand held device holder 200 encasing hand held device case 20 In FIG. 14, elastic member 4d and 4c are secured to anchor 2 and engaged to hand held device case 20 by being looped over the corners of hand held device case 20. Fastener 14c is shown securing elastic member 4d and 4c. Fasteners 14d and 14b are shown securing portions of elastic members 4d and 4c. Camera lens partition 12 is engaged partially into elastic members 4a. Vertical support ring 6 is shown connected to elastic member 4d. Hook 8 is shown engaged to vertical support ring 6. Fastener 14e is shown securing a portion of elastic member 4d. Fastener 14f is shown securing a portion of elastic member 4c.

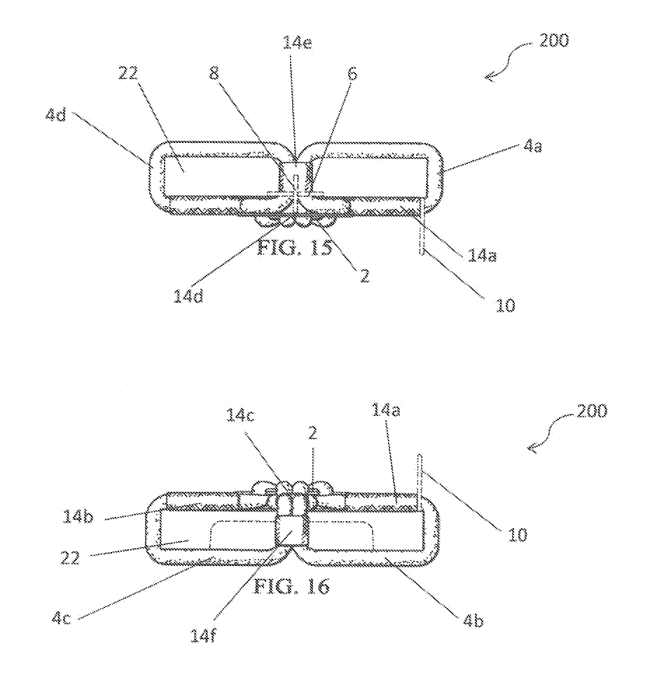

FIG. 15 depicts a top view of hand held device holder 200 encasing hand held device case 20. Elastic members 4a and 4d are secured to anchor 2 and looped over the corners of hand held device case 20. Fastener 14d and 14e both secure elastic members 4a and 4d together. Fastener 14a secures a portion of elastic member 4a. Fastener 14c secures a portion of elastic member 4d. Vertical support ring 6 is connected to elastic members 4a and 4d. Hook 8 is connected to vertical support ring 6. Lateral support ring 10 is connected to elastic member 4a.

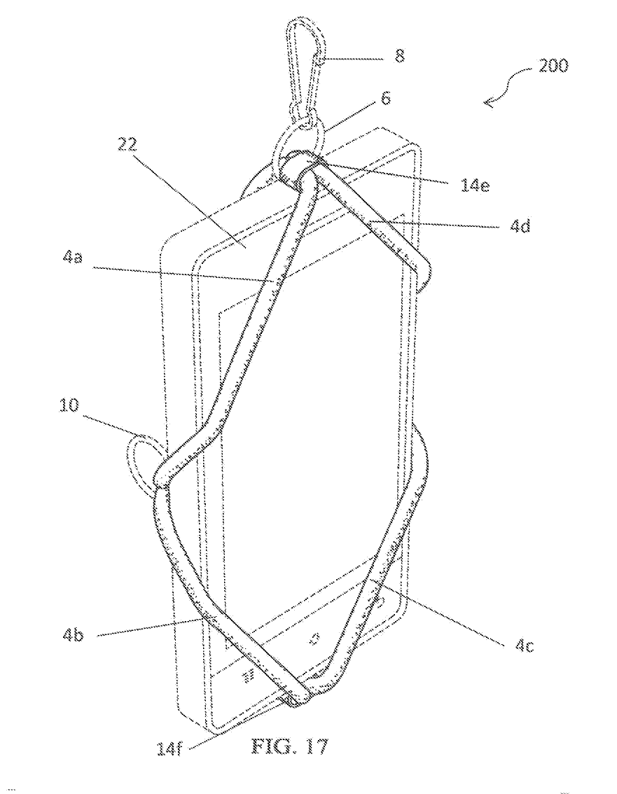

FIG. 16 depicts a bottom view of hand held device holder 200 encasing hand held device case 20. Elastic members 4b and 4c are secured to anchor 2 and looped over the corners of hand held device case 20. Fastener 14c and 14f both secure elastic members 4b and 4c together. Fastener 14a secures a portion of elastic member 4b. Fastener 14c secures a portion of elastic member 4c. Lateral support ring 10 is connected to elastic member 4b.

FIG. 17 depicts an isometric view of the front of hand held device holder 200 encasing hand held device case 20. Elastic members 4a-4d are engaged to hand held device case 20 by looping over the corners of hand held device case 20 creating a frame like appearance. Elastic members 4a and 4d are secured together by a fastener 14e to provide a suspension base for optional vertical support ring 6. Optional hook 8 is shown connected to vertical support ring 6 for easier suspension of hand held device holder 200. Optional lateral supporting ring 10 is shown connected to elastic members 4a and 4b. Elastic members 4b and 4c are also optionally secured together by fastener 14f for additional tension.

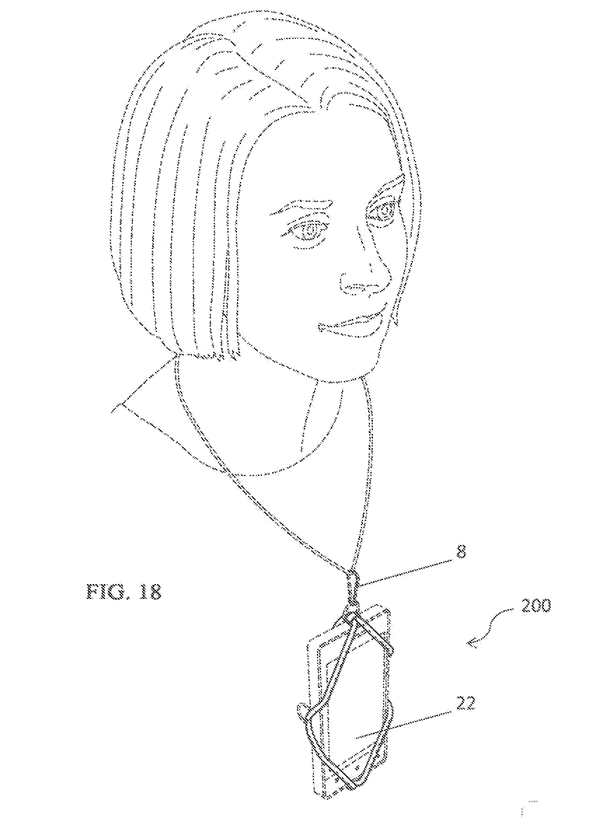

FIG. 18 depicts an isometric view of the front of hand held device holder 200 encasing hand held device case 20 and being used for a proposed use. FIG. 18 shows hook 8 connected to a necklace enabling a user to wear hand held device holder 200 around the neck.

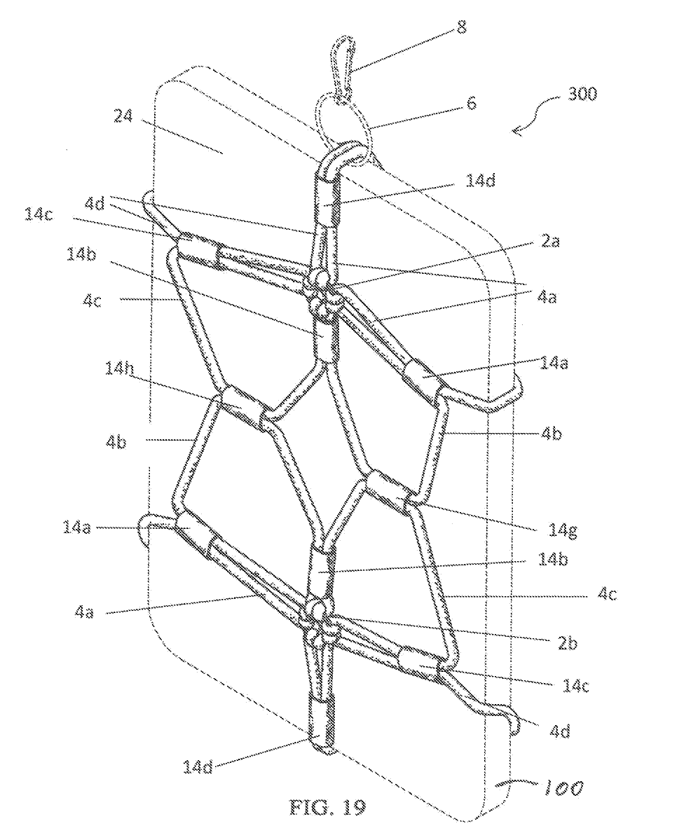

FIG. 19 depicts an isometric view of the back of the hand held device holder 300 according to another embodiment of the present invention. Hand held device holder 300 has a dual anchor system with anchor 2a and anchor 2b. Hand held device holder 300 is essentially two hand held device holders secured together at fastener 14g and 14h. Fastener 14g secures elastic member 4b, which is secured to anchor 2a and elastic member 4c secured to anchor 2b. Fastener 14h secures elastic member 4c secured to anchor 2a with elastic member 4b secured to anchor 2b. In hand held device holder 300, a set of elastic members 4a-4d is secured to anchor 2a. A second set of elastic members 4a-4d is secured to anchor 2b. In this embodiment, a portion of elastic member 4a on both is further secured to a portion of elastic member 4b on both by a fastener 14a. Fastener 14a-d on both devices provide hand held device holder 300 with additional support and tension when engaged to a hand held device 24. Elastic members 4b and 4c, 4c and 4d, and 4d and 4a on both devices are also similarly secured together by two sets of fastener 14b-d, respectively. FIG. 19 also shows hand held device holder 300 encasing hand held device 24 by engaging elastic members 4a and 4d of both devices to the corners of hand held device 24. Elastic members 4a and 4d secured to anchor 2a are looped over the corners of hand held device 24, and elastic members 4a and 4d secured to anchor 2b looped over the other two remaining corners of hand held device 24. FIG. 19 also depicts hand held device holder 300 with optional vertical support ring 6 connected to elastic members 4a and 4d secured to anchor 2a. Vertical support ring 6 can optionally be further connected to a hook 8 for easier suspension or carrying of the hand held device holder 300 encasing hand held device 24.

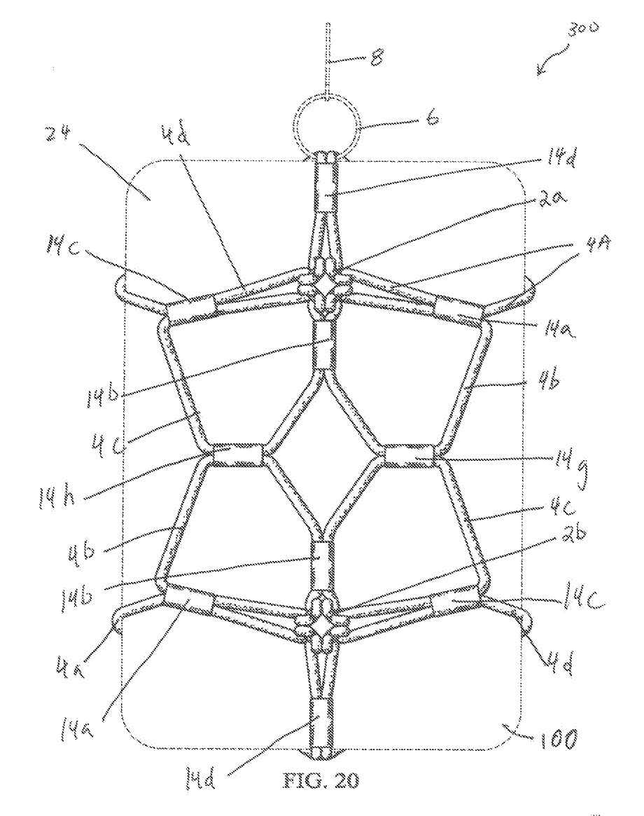

FIG. 20 depicts a back view hand held device holder 300 encasing hand held device 24. Hand held device holder 300 has a dual anchor system with anchor 2a and anchor 2b. Hand held device holder 300 is essentially two hand held device holders secured together at fastener 14g and 14h. Fastener 14g secures elastic member 4b, which is secured to anchor 2a and elastic member 4c secured to anchor 2b. Fastener 14h secures elastic member 4c secured to anchor 2a with elastic member 4b secured to anchor 2b. In hand held device holder 300, a set of elastic members 4a-4d is secured to anchor 2a. A second set of elastic members 4a-4d is secured to anchor 2b. In this embodiment, a portion of elastic member 4a on both devices is further secured to a portion of elastic member 4b on both by a fastener 14a. Two sets of fastener 14a-d used for both devices provide hand held device holder 300 with additional support and tension when engaged to a hand held device 24. Elastic members 4b and 4c, 4c and 4d, and 4d and 4a on both devices are also similarly secured together by two sets of fastener 14b-d, respectively. FIG. 20 also shows hand held device holder 300 encasing hand held device 24 by engaging elastic members 4a and 4d of both devices to the corners of hand held device 24. Elastic members 4a and 4d secured to anchor 2a are looped over the corners of hand held device 24, and elastic members 4a and 4d secured to anchor 2b looped over the other two remaining corners of hand held device 24. FIG. 20 also depicts hand held device holder 300 with optional vertical support ring 6 connected to elastic members 4a and 4d secured to anchor 2a. Vertical support ring 6 can optionally be further connected to a hook 8 for easier suspension or carrying of the hand held device holder 300 encasing hand held device 24.

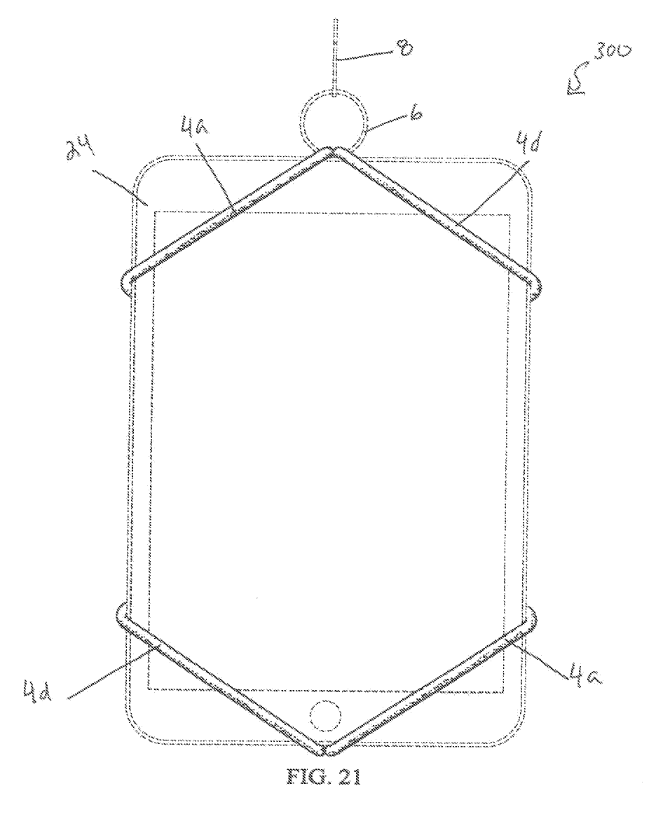

FIG. 21 depicts a front view of hand held device holder 300 encasing hand held device 24. Elastic members 4a and 4d secured to anchor 2a (not shown), and elastic members 4a and 4d secured to anchor 2b (not shown) are engaged to hand held device 24 by looping over the corners of hand held device 24 creating a frame like appearance. Optional hook 8 is shown connected to vertical support ring 6 for easier suspension of hand held device holder 300.

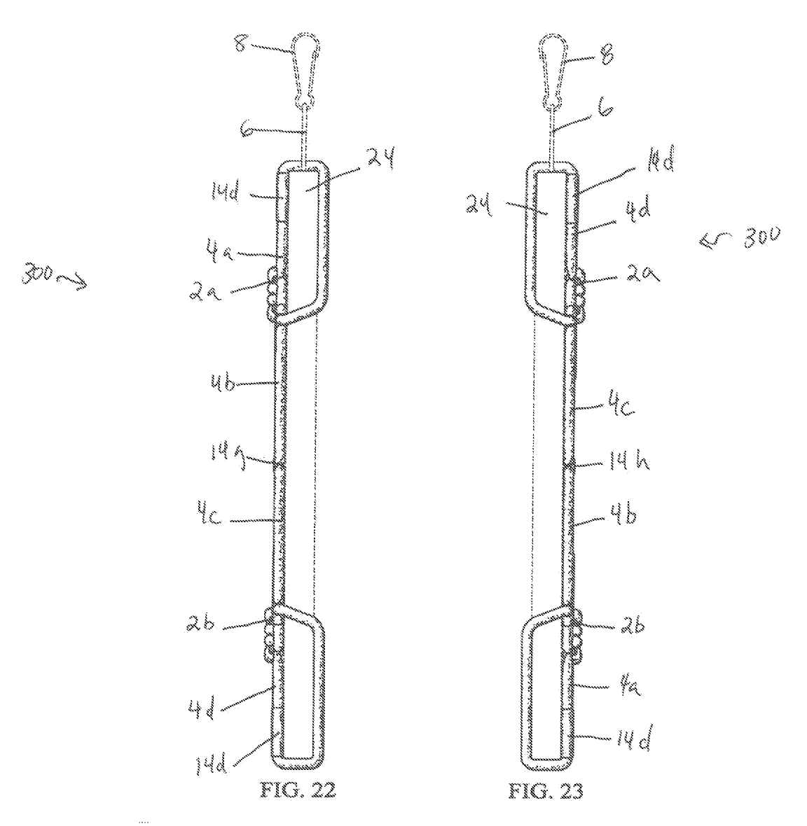

FIGS. 22 and 23 depict side views of hand held device holder 300 encasing hand held device 24. In FIG. 22, elastic member 4a secured to anchor 2a and elastic member 4d secured to anchor 2b are engaged to hand held device 24 by being looped over the corners of hand held device 24. A Fastener 14d is shown securing a portion of elastic member 4a secured to anchor 2a. Another fastener 14d secures a portion of elastic member 4d secured to anchor 2b. Fastener 14g secures elastic member 4b, which is secured to anchor 2a with elastic member 4c secured to anchor 2b. Vertical support ring 6 is shown connected to elastic member 4a. Hook 8 is shown engaged to vertical support ring 6. FIG. 23 shows an opposite side view of hand held device holder 300 encasing hand held device 24 In FIG. 23, elastic member 4d secured to anchor 2a and elastic member 4a secured to anchor 2b are engaged to hand held device 24 by being looped over the corners of hand held device 24. A Fastener 14d is shown securing a portion of elastic member 4d secured to anchor 2a. Another fastener 14d secures a portion of elastic member 4a secured to anchor 2b. Fastener 14h secures elastic member 4c secured to anchor 2a with elastic member 4b secured to anchor 2b. Vertical support ring 6 is shown connected to elastic member 4a. Hook 8 is shown engaged to vertical support ring 6.

FIG. 24 depicts a top view of hand held device holder 300 encasing hand held device 24. Elastic members 4a and 4d are secured to anchor 2a and looped over the corners of hand held device 24. Fastener 14c secures a portion of elastic member 4d. Fastener 14a secures a portion of elastic member 4a. Vertical support ring 6 is connected to elastic members 4a and 4d. Hook 8 is connected to vertical support ring 6.

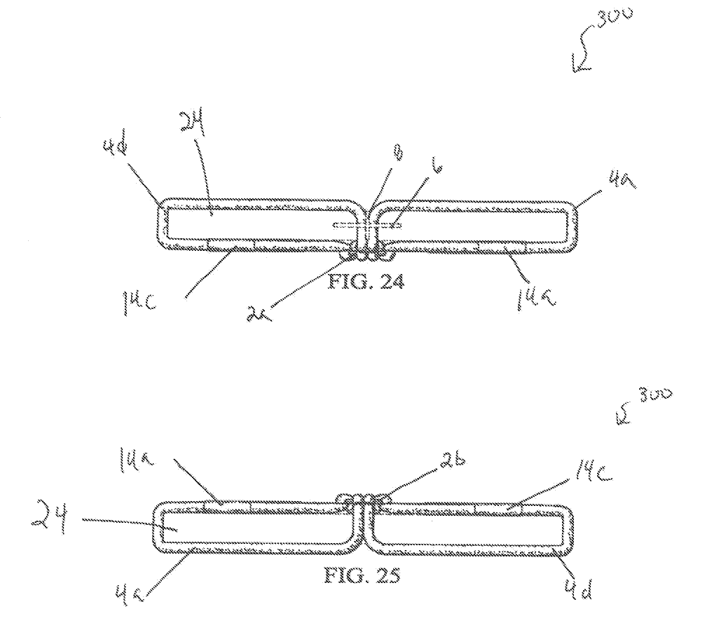

FIG. 25 depicts a bottom view of hand held device holder 300 encasing hand held device 24. Elastic members 4a and 4d are secured to anchor 2b and looped over the corners of hand held device 24. Fastener 14c secures a portion of elastic member 4d. Fastener 14a secures a portion of elastic member 4a.

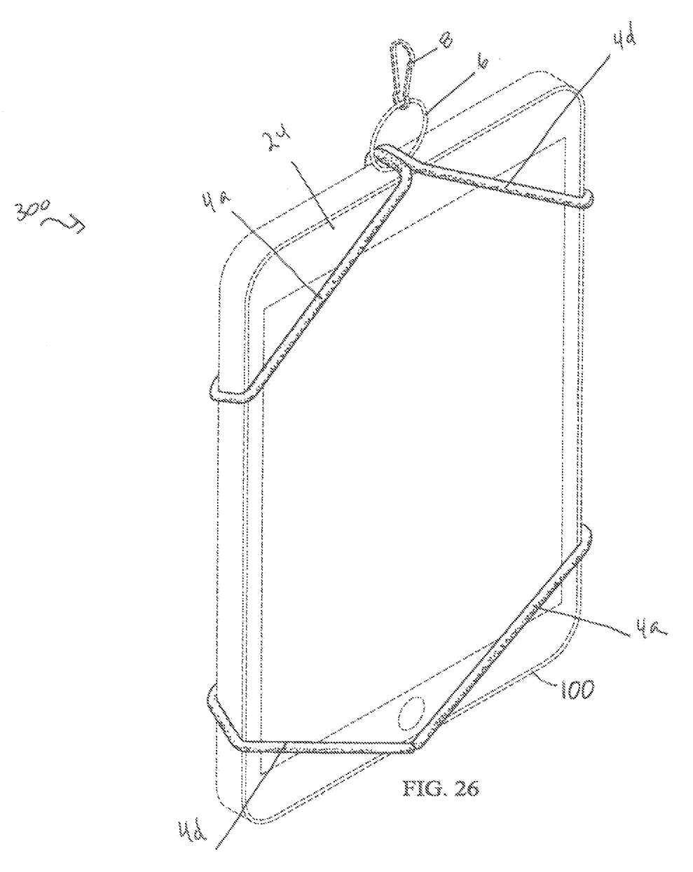

FIG. 26 depicts an isometric view of the front of hand held device holder 300 encasing hand held device 24. Elastic members 4a and 4d secured to anchor 2a (not shown), and elastic members 4a and 4d secured to anchor 2b (not shown) are all engaged to hand held device 24 by each looping over a corner of hand held device 24 creating a frame like appearance. Optional hook 8 is shown connected to vertical support ring 6 for easier suspension of hand held device case 100. Vertical support ring is connected to elastic member 4a and 4d that are secured to anchor 2a (not shown).

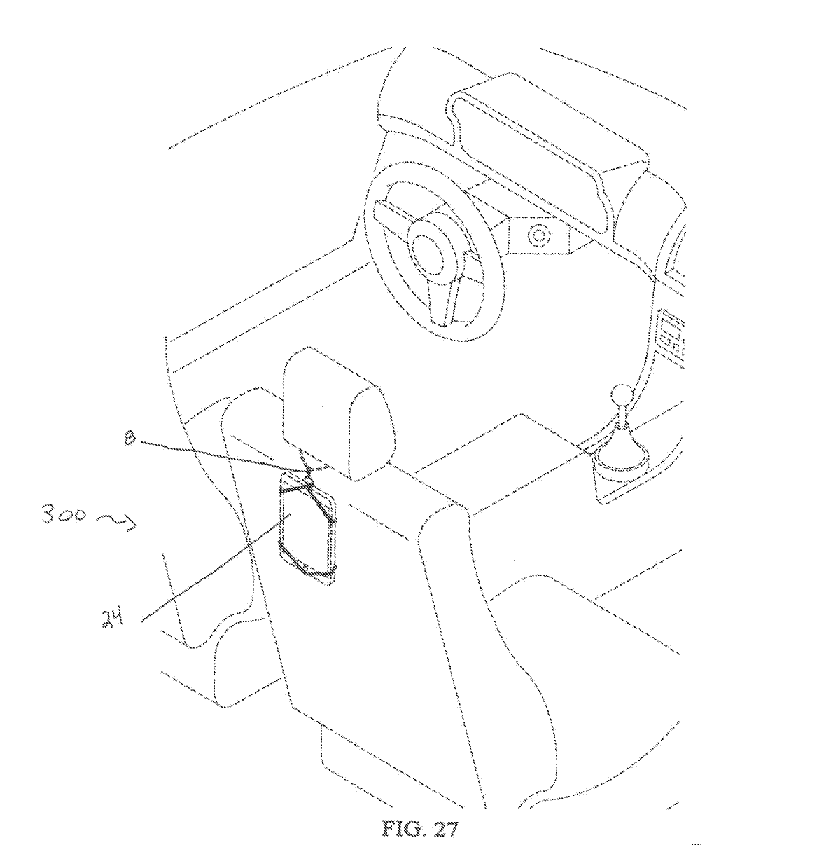

FIG. 27 depicts an isometric view of the front of hand held device holder 300 encasing hand held device 24 and being used for a proposed use. FIG. 27 shows hook 8 connected to a mount enabling a user to hand held device holder hand held device holder 300 encasing hand held device 24 around the headrest of a car.

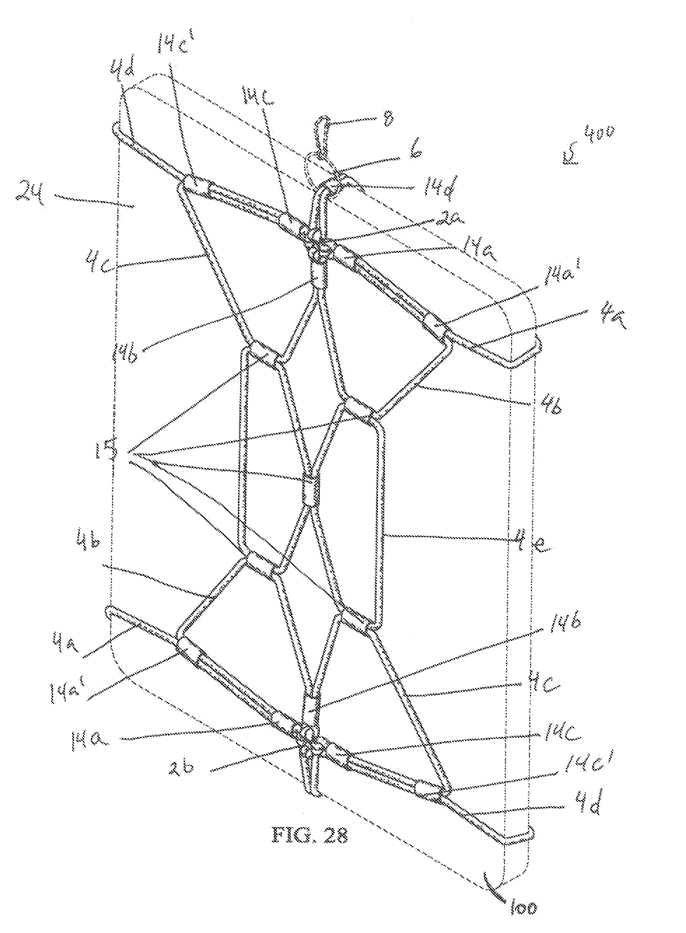

FIG. 28 depicts an isometric view of the back of the hand held device holder 400 according to another embodiment of the present invention. Hand held device holder 400 has a dual anchor system with anchor 2a and anchor 2b. Hand held device holder 400 is essentially two hand held device holders connected together by an additional elastic member 4e. A series of fastener 15 are used to secure elastic member 4b and 4c that are secured to anchor 2a to elastic member 4e. Fastener 15 is also used to secure elastic members 4b and 4c that are secured to anchor 2b to elastic member 4e. In hand held device holder 400, a set of elastic members 4a-4d is secured to each of anchor 2a and 2b. In this embodiment, a portion of elastic member 4a on both devices (one device centered on anchor 2a being connected to the other device centered on anchor 2b) is further secured to a portion of elastic member 4b on both by a fastener 14a. Elastic members 4a and 4b on both devices are further secured by an additional fastener 14a′ for additional tension and security. Fastener 14a-d on both devices provide hand held device holder 400 with additional support and tension when engaged to a hand held device 100. Elastic members 4b and 4c, 4c and 4d, and 4d and 4a on both devices are also similarly secured together by two sets of fastener 14b-d, respectively. Elastic members 4c and 4d on both devices are also further secured by an additional fastener 14c′ for additional tension and security.

FIG. 28 also shows hand held device holder 400 encasing hand held device 100 by engaging elastic members 4a and 4d of both devices to the corners of hand held device 100. Elastic members 4a and 4d secured to anchor 2a are looped over the corners of hand held device 100, and elastic members 4a and 4d secured to anchor 2b looped over the other two remaining corners of hand held device 100. FIG. 28 also depicts hand held device holder 400 with optional vertical support ring 6 connected to elastic members 4a and 4d secured to anchor 2a. Vertical support ring 6 can optionally be further connected to a hook 8 for easier suspension or carrying of the hand held device holder 400 encasing hand held device 100.

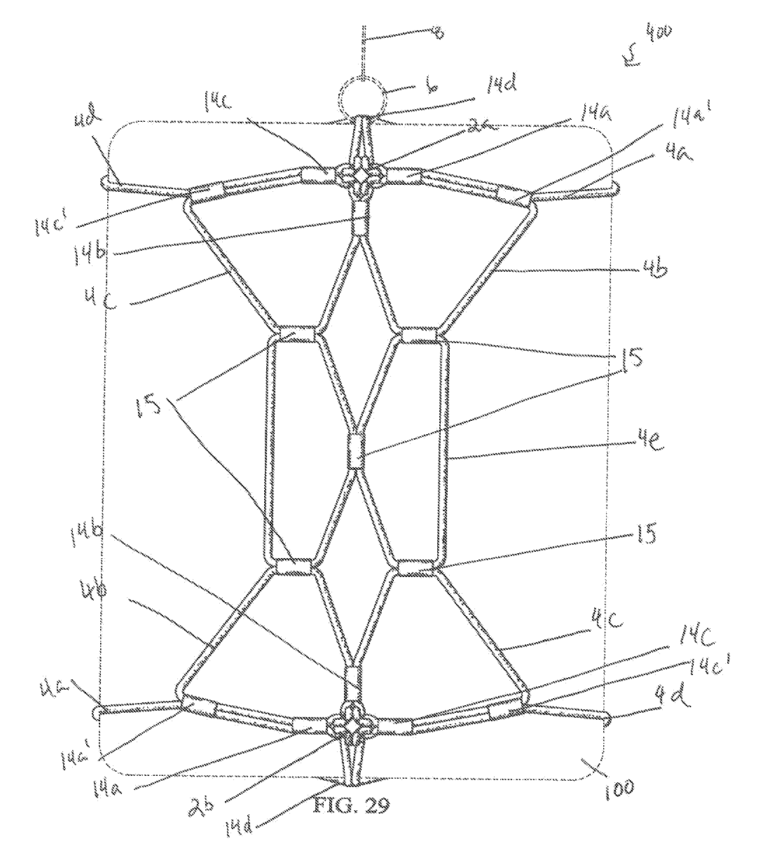

FIG. 29 depicts a back view of hand held device holder 400 encasing a hand held device case 100. Hand held device holder 400 has a dual anchor system with anchor 2a and anchor 2b. Hand held device holder 400 is essentially two hand held device holders connected together by an additional elastic member 4e. A series of fastener 15 are used to secure elastic member 4b and 4c that are secured to anchor 2a to elastic member 4e. Fastener 15 is also used to secure elastic members 4b and 4c that are secured to anchor 2b to elastic member 4e. In hand held device holder 400, a set of elastic members 4a-4d is secured to each of anchor 2a and 2b. In this embodiment, a portion of elastic member 4a on both devices (one device centered on anchor 2a being connected to the other device centered on anchor 2b) is further secured to a portion of elastic member 4b on both by a fastener 14a. Elastic members 4a and 4b on both devices are further secured by an additional fastener 14a′ for additional tension and security. Fastener 14a-d on both devices provide hand held device holder 400 with additional support and tension when engaged to a hand held device case 100. Elastic members 4b and 4c, 4c and 4d, and 4d and 4a on both devices are also similarly secured together by two sets of fastener 14b-d, respectively. Elastic members 4c and 4d on both devices are also further secured by an additional fastener 14c′ for additional tension and security.

FIG. 29 also shows hand held device holder 400 encasing hand held device 24 by engaging elastic members 4a and 4d of both devices to the corners of hand held device case 100. Elastic members 4a and 4d secured to anchor 2a are looped over the corners of hand held device case 100, and elastic members 4a and 4d secured to anchor 2b looped over the other two remaining corners of hand held device 24. FIG. 29 also depicts hand held device holder 400 with optional vertical support ring 6 connected to elastic members 4a and 4d secured to anchor 2a. Vertical support ring 6 can optionally be further connected to a hook 8 for easier suspension or carrying of the hand held device holder 400 encasing hand held device case 100.

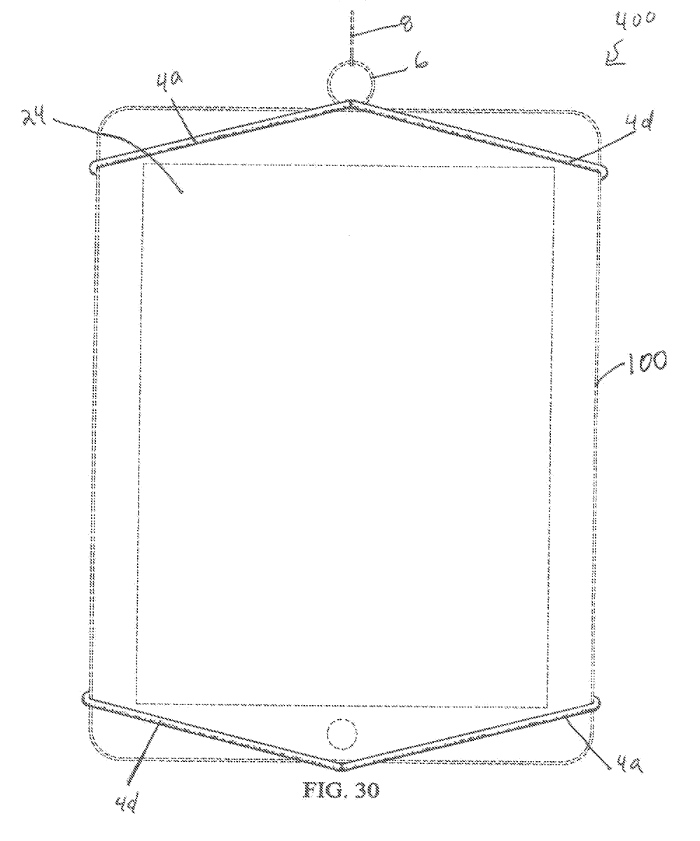

FIG. 30 depicts a front view of hand held device holder 400 encasing hand held device case 100. Elastic members 4a and 4d secured to anchor 2a (not shown), and elastic members 4a and 4d secured to anchor 2b (not shown) are engaged to hand held device case 100 that protects hand held device 24 by looping over the corners of hand held device case 100 creating a frame like appearance. Optional hook 8 is shown connected to vertical support ring 6 for easier suspension of hand held device holder 400.

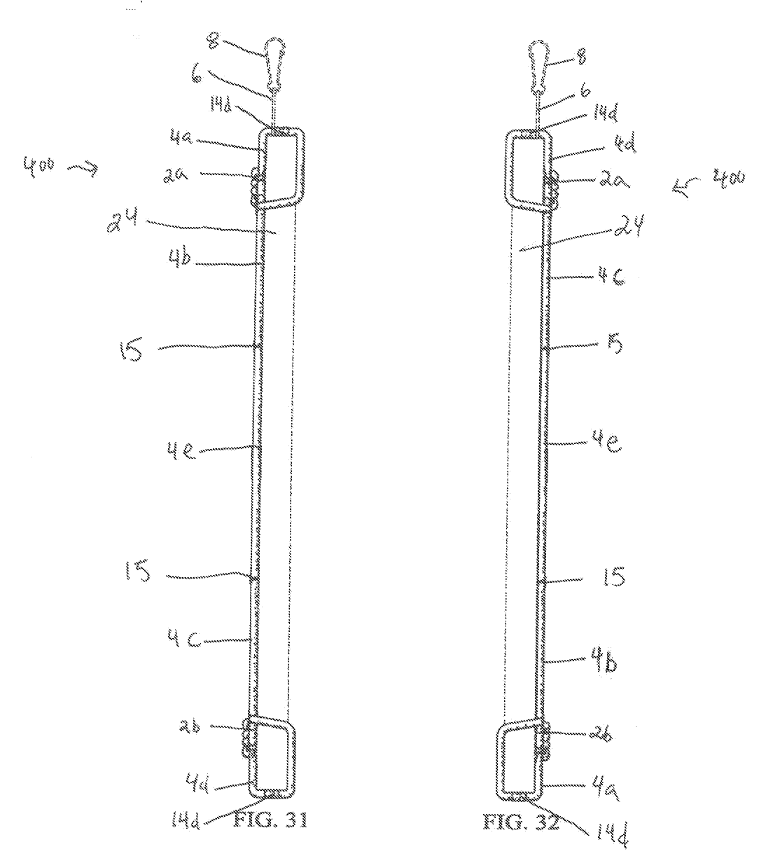

FIGS. 31 and 32 depict side views of hand held device holder 400 encasing hand held device 24. In FIG. 31, elastic member 4a secured to anchor 2a and elastic member 4d secured to anchor 2b are engaged to hand held device 24 by being looped over the corners of hand held device 24. A Fastener 14d is shown securing a portion of elastic member 4a that is secured to anchor 2a. Another fastener 14d secures a portion of elastic member 4d secured to anchor 2b. Fastener 15 secures elastic member 4b secured to anchor 2a with elastic member 4e. Another fastener 15 also secures elastic member 4c secured to anchor 2b with elastic member 4e. Vertical support ring 6 is shown connected to elastic member 4a. Hook 8 is shown engaged to vertical support ring 6. FIG. 32 shows an opposite side view of hand held device holder 400 encasing hand held device 24 In FIG. 32, elastic member 4d secured to anchor 2a and elastic member 4a secured to anchor 2b are engaged to hand held device 24 by being looped over the corners of hand held device 24. Fastener 15 secures elastic member 4c secured to anchor 2a with elastic member 4e. Another fastener 15 also secures elastic member 4b secured to anchor 2b with elastic member 4e. Vertical support ring 6 is shown connected to elastic member 4a. Hook 8 is shown engaged to vertical support ring 6.

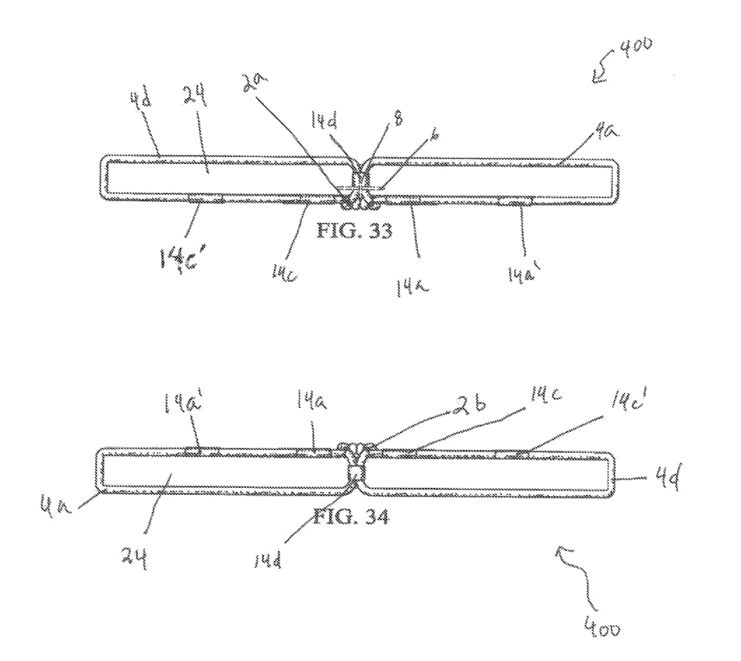

FIG. 33 depicts a top view of hand held device holder 400 encasing hand held device 24. Elastic members 4a and 4d are secured to anchor 2a and looped over the corners of hand held device 24. Fastener 14c secures a portion of elastic member 4d. Fastener 14c′ also secures another portion of elastic member 4d. Fastener 14a′ secures a portion of elastic member 4a. Fastener 14d secures elastic member 4d to elastic member 4a. Vertical support ring 6 is connected to elastic members 4a and 4d. Hook 8 is connected to vertical support ring 6.

FIG. 34 depicts a bottom view of hand held device holder 400 encasing hand held device 24. Elastic members 4a and 4d are secured to anchor 2b and looped over the corners of hand held device 24. Fastener 14c secures a portion of elastic member 4d. Fastener 14c′ secures another portion of elastic member 4d. Fastener 14a secures a portion of elastic member 4a. Fastener 14a′ secures a portion of elastic member 4a. Fastener 14d secures elastic member 4a to elastic member 4d.

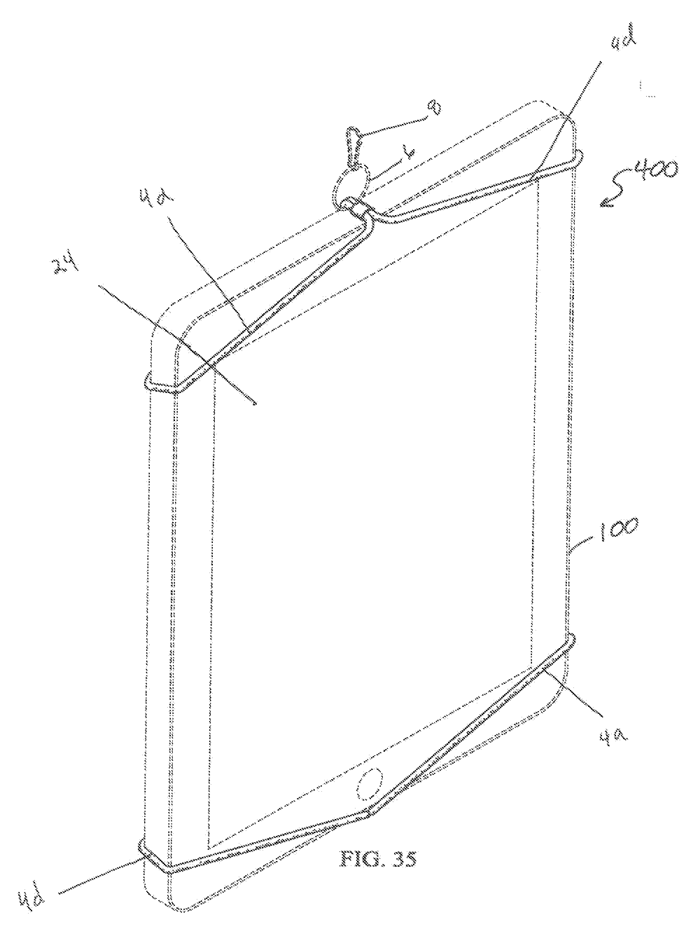

FIG. 35 depicts an isometric view of the front of hand held device holder 400 encasing hand held device case 100 surrounding hand held device 24. Elastic members 4a and 4d secured to anchor 2a (not shown), and elastic members 4a and 4d secured to anchor 2b (not shown) are all engaged to hand held device case 100 by each looping over a corner of hand held device case 100 creating a frame-like appearance. Optional hook 8 is shown connected to vertical support ring 6 for easier suspension of hand held device case 100. Vertical support ring is connected to elastic member 4a and 4d that are secured to anchor 2a (not shown).

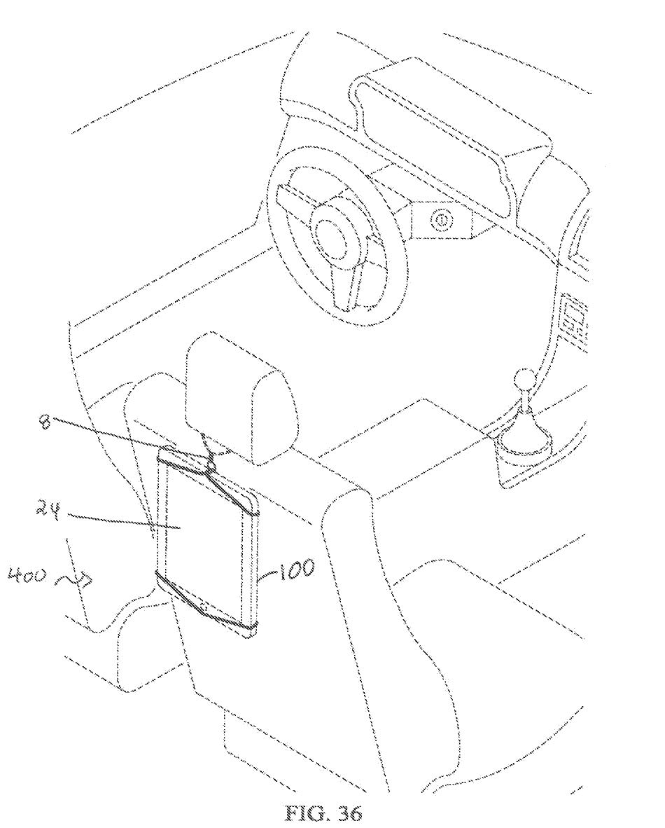

FIG. 36 depicts an isometric view of the front of hand held device holder 400 encasing hand held device case 100 and being used for a proposed use. FIG. 36 shows hook 8 connected to a mount enabling a user to hand held device holder hand held device holder 400 encasing hand held device case 100 surrounding a hand held device 24 around the headrest of a car.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. An adjustable hand held device holder, comprising:
an anchor;
a first, a second, a third, and a fourth elastic member, wherein the first, second, third and fourth elastic members are secured to the anchor, and wherein at least three of the elastic members are adapted to engage at least three edges or corners of a hand held device.

2. The holder of claim 1, wherein a portion of at least one elastic member is secured to a portion of another elastic member to provide tension and a suspension base.

3. The holder of claim 1, wherein the first, second, third, and fourth elastic members are each elastic bands adapted to engage the edges or corners of a hand held device.

4. The holder of claim 1, wherein each elastic member further comprises hooks adapted to engage the edges or corners of the hand held device.

5. The holder of claim 1, further comprising at least one ring engaged with at least one elastic member to enable the adjustable hand held device holder to be suspended.

6. The holder of claim 5, further comprising at least one hook engaged with at least one ring or one elastic member, to enable the holder to be suspended.

7. The holder of claim 1, further comprising a camera lens partition to provide a viewing opening for a camera lens.

8. The holder of claim 1, further comprising an additional anchor wherein a fifth, a sixth, a seventh, and an eighth elastic member are secured to the additional anchor, and at least one of the elastic members secured to the additional anchor are secured to at least one of the elastic members secured to the anchor.

9. The holder of claim 8, wherein at least one of the elastic members secured to the additional anchor is connected to at least one of the elastic members secured to the anchor by at least one separate elastic member.

10. A method of holding a hand held device comprising:
obtaining an adjustable hand held device holder, comprising:
a anchor;
a first, a second, a third, and a fourth elastic member, wherein the first, second, third and fourth elastic members are secured to the anchor, and at least three of the elastic members are adapted to engage at least three edges or corners of a hand held device; and
securing at least three of the elastic members to at least three edges or corners of the hand held device.

11. The method of claim 10, wherein a portion of at least one elastic member of the adjustable hand held device holder is secured to a portion of another elastic member to provide tension and a suspension base.

12. The method of claim 10, wherein the first, second, third, and fourth elastic members of the adjustable hand held device holder are each elastic bands adapted to engage the edges or corners of the hand held device.

13. The method of claim 10, wherein each elastic member of the adjustable hand held device holder further comprises hooks adapted to engage the edges or corners of the hand held device.

14. The method of claim 10, wherein the adjustable hand held device holder further comprise at least one ring engaged with at least one elastic member to enable the adjustable hand held device holder to be suspended.

15. The method of claim 14, wherein the adjustable hand held device holder further comprise at least one hook engaged with at least one ring or one elastic member, to enable the holder to be suspended.

16. The method of claim 10, wherein the adjustable hand held device holder further comprises a camera lens partition to provide a viewing opening for a camera lens.

17. The method of claim 10, wherein the adjustable hand held device holder further comprise an additional anchor, wherein a fifth, a sixth, a seventh, and an eighth elastic member are secured to the additional anchor, and at least one of the elastic members secured to the additional anchor are secured to at least one of the elastic members secured to the anchor.

18. The method of claim 17, wherein at least one of the elastic members of the adjustable hand held device holder secured to the additional anchor is connected to at least one of the elastic members secured to the anchor by at least one separate elastic member.

19. An adjustable hand held device holder, comprising:
an anchor;
a first, a second, a third, and a fourth elastic member, wherein the first, second, third and fourth elastic members are secured to the anchor, and wherein the elastic members are adapted to engage the edges or corners of a hand held device; and
a fastener slidably securing a portion of each elastic member to a portion of an adjacent elastic member to provide tension.

20. The holder of claim 19, further comprising a camera lens partition to provide a viewing opening for a camera lens.
